(19) United States
(12) Patent Application Publication
(10) Pub. No.: US 2010/0155991 A1
(43) Pub. Date: Jun. 24, 2010

(54) METHOD OF MANUFACTURING A BUSHING

(75) Inventors: David C. Hughes, Rubicon, WI (US); Marie Way, Burlington, WI (US); Mark Kadow, Pewaukee, WI (US)

Correspondence Address: LARSON NEWMAN & ABEL, LLP, 5914 WEST COURTYARD DRIVE, SUITE 200, AUSTIN, TX, 78730, US

(73) Assignee: Cooper Industries, Ltd., Houston, TX (US)

(21) Appl. No.: 12/715,003

(22) Filed: Mar. 1, 2010

Related U.S. Application Data
(62) Division of application No. 12/197,930, filed on Aug. 25, 2008, now Pat. No. 7,708,576.

(51) Int. Cl. B29C 45/14

(52) U.S. Cl. 264/272.11

(57) ABSTRACT

A bushing can include a shoulder, a ring, and a ground shield. The ring can be arranged circumferentially around a first outside diameter of the bushing, wherein the ring includes a channel. The ground shield can include a semiconductive rubber collar that forms part of an outer surface of the bushing and extends circumferentially under a portion of the ring. The insulative portion can be adjacent to the ring and disposed over a portion of the ground shield. A method of manufacturing the bushing can include placing the ring and the ground shield into a mold, the ground shield including holes therein, and injecting insulative material into the mold to create an insulative layer within a cavity formed by the ring and the ground shield, the holes in the ground shield allowing some of the insulating material to flow therethrough to create the insulative portion adjacent the ring.

### CROSS REFERENCE TO RELATED APPLICATION

The present application is a divisional application from and claims priority under 35 U.S.C. §120 to U.S. patent application Ser. No. 12/197,930, entitled “Electrical Connector” by Hughes et al. filed on Aug. 25, 2008, which is assigned to the current assignee hereof and incorporated by reference in its entirety.

### TECHNICAL FIELD

The present description relates, in general, to electrical connectors and, more specifically, to electrical connectors with improved insulating features that can help to inhibit flashover.

### BACKGROUND

In underground electrical distribution systems that are energized to, e.g., 15 kV to 35 kV, it is common to employ high-voltage connector assemblies of the elbow/bushing variety. The IEEE STD 386 standard covers such electrical connectors. In their earliest and most basic form, bushing inserts had a squared-off shoulder with no venting and no latch indication, where the shoulder of the bushing is the area where the cuff of the elbow fits against the bushing. Oftentimes, bushing/elbow assemblies allow for connection and disconnection when the line is carrying current (i.e., loadmake and loadbreak operations).

FIG. 6 is an illustration of terminator/bushing assembly 600, which is one prior art embodiment. Assembly 600 includes elbow terminator 610 and bushing insert 620. Elbow terminator 610 includes sleeve 612, cuff 611, and probe 613. When latched, sleeve 612 fits over bushing insert 620 such that the inner surface of cuff 611 fits snugly up against shoulder 621, and probe 613 is received into conductive tube 622. In FIG. 6, terminator 610 and bushing insert 610 are not drawn to the same scale.

At 25 kV there have been problems in the industry for many years concerning a phenomenon known as partial vacuum-induced flashover. Rarely, when an operator would pull an elbow off of a bushing, there would be an arc from the exposed conductive insert (of the elbow) to a conductive grounding shield on the bushing. It was discovered that flashover is caused by a decrease in the dielectric constant of the air trapped in the assembly due to a partial vacuum during loadbreak operations. In IEEE STD 386 elbow/bushing assemblies, the cuff of the elbow overlaps the collar of the bushing by about ½ inch, so that the first ½ inch of travel during a loadbreak operation creates a volume inside the elbow-bushing interface connection. The volume of air becomes greater without letting any other air enter the assembly, thereby lowering the pressure of the air. When air pressure is lowered, the dielectric strength of that air is also lowered, as described in Paschen's curve. The lowered dielectric strength of the air leads to lowered resistance and sometimes, arcing.

One prior solution to the flashover problem includes the use of additional insulation in the elbow terminator. Such a solution is described in U.S. Pat. No. 5,655,921, which is incorporated by reference herein. Furthermore, U.S. Pat. No. 5,655,921 also shows the use of an insulating layer placed over a grounding shield to prevent flashover.

Yet another approach includes decreasing or relieving the partial vacuum as it occurs. One such solution uses a vented bushing insert, which has slots and grooves on its shoulder to allow air to go underneath the cuff of the elbow and relieve the air pocket that is between the cuff of the elbow and the shoulder of the bushing. One problem with that design is that it only vents one of the cavities in which the vacuum is created, while leaving other small cavities unaddressed, e.g., the areas around the nose of the bushing.

Another problem with vented bushings is that the vents get plugged up with grease. When linemen put elbows and inserts together, they typically use silicone lubricants to slide the two rubber pieces together. It is an interference fit that is very tight, and the lubrication makes the elbows operable over the next twenty to thirty years. Over time, the lubrication thickens up, turns gluey, and will clog up the vents, making the elbow harder to operate, and pulling more vacuum. More vacuum leads to a greater chance of flashover. An example of a vented shoulder is shown in U.S. Pat. No. 6,939,151.

The difference in performance between the insulated elbow solution and the vented bushing solution led to changes in the IEEE standard for testing bushing elbow assemblies. The OIACWT, (Operating Interface AC Withstand Test) provides a way for testing new elbow/bushing designs. There are two tests in the standard-Option A and Option B. Option A is a partial vacuum test at 27.5 kV, with no lubricant, and Option B is a partial vacuum test with aged lubricant at 30.5 kV.

A beveled insert is the focus of another solution technique. A beveled insert refers to a bushing insert where the shoulder of the bushing is chamfered. Usually, the shoulder of a bushing is a ninety-degree corner per the IEEE STD 386 standard, but in a beveled insert, the corner is at a much shallower angle, e.g., forty-five degrees. The shallower angle keeps the cuff of the elbow from sealing to the shoulder of the bushing, thereby preventing partial vacuum from occurring. In order to further reduce cuff/shoulder sealing, some beveled inserts include flange-like protrusions that extend radially outward from the beveled surface.

Yet another solution includes using a J-ring adjacent to the shoulder of the bushing to relieve the partial vacuum at a short travel distance of the cuff. An example of a J-ring solution is shown in U.S. Pat. No. 7,083,450, which is incorporated by reference herein. J-ring solutions attempt to prevent cuff-shoulder sealing by changing the geometry of the outside surface of the bushing so that the cuff cannot create a seal during loadbreak. The J-ring design is similar to a counterbore design with an added protrusion, an example of which is labeled 115 in FIG. 3 of U.S. Pat. No. 7,083,450. The protrusion prevents the tip of the cuff from sealing along the bottom shelf of the counterbore. Once the tip of the cuff clears the point of the protrusion, it allows air to flow around the cuff of the bushing, thereby relieving any partial vacuum.

It is important to note that the J-ring design relieves vacuum differently from the other designs. Vented shoulders and beveled inserts hold the cuff outward to allow air to go underneath the cuff, whereas a J-ring design allows the cuff to fall. Typically, J-ring designs do not succumb to grease pack like vented shoulders do. Further, because so much material is taken away from the insert due to the counterbore, the starting volume of trapped air when the elbow is mated to the insert is much greater than that of the beveled insert and the vented insert. Thus, the pressure drop is not as severe, simply because the starting volume in the steady state latched position is so much greater than the general design. Thus, J-ring solutions provide better vacuum-relieving properties than other currently-available solutions.

### SUMMARY

Various embodiments of the invention improve upon J-ring solutions by providing superior insulating properties in order to further reduce the incidents of flashover. For example, some embodiments place a layer of insulating material over a high-electrical-stress portion or a grounding shield adjacent to the J-ring. Areas of high electrical stress include a ridge or point formed by semiconductive material where the semiconductive material abuts the J-ring. Sharp ridges or point manipulate electric fields and can attract arcs. By placing a high-electrical-stress area under a layer of insulating material, the embodiment prevents arcing.

Other embodiments are directed to methods of making J-ring inserts with improved electrical properties. Some embodiments include manufacturing individual components of a bushing insert, such as a J-ring, a grounding shield, and a housing for the inner conductive parts of the bushing. The components are placed in an injection mold, where insulative rubber is injected to create a non-conductive portion in the space defined by the J-ring, the grounding shield, and the housing for the inner conductive parts. In some embodiments, the layer of insulative material that covers part of the grounding shield is manufactured as a separate component that is placed in the injection mold with the other components. In another example, the J-ring and the insulative layer are manufactured as a single component and placed into the mold with the other components. In yet another example, the grounding shield has holes there that allow the rubber fill to flow therethrough so that the layer of insulating material is formed from the rubber fill.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

FIG. 1A is a cut-away illustration of an exemplary bushing insert adapted according to one embodiment of the invention;

FIG. 1B shows a more detailed cut-away view of the interface of the various material surrounding the I-ring of FIG. 1A;

FIG. 2 is an illustration of an exemplary bushing adapted according to one embodiment of the invention;

FIG. 3 is an illustration of an exemplary bushing insert adapted according to one embodiment of the invention;

FIG. 4 is an illustration of an exemplary bushing adapted according to one embodiment of the invention;

FIG. 5 is an illustration of an exemplary bushing adapted according to one embodiment of the invention;

FIG. 6 is an illustration of elbow/bushing assembly 600, which is one prior art embodiment.

### DETAILED DESCRIPTION

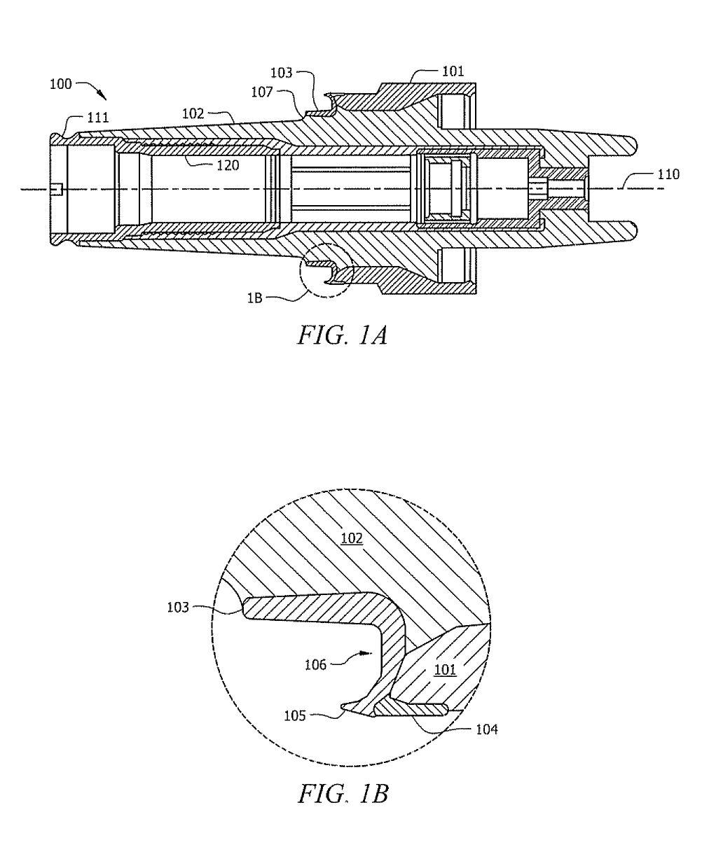

FIG. 1A is a cut-away illustration of exemplary bushing insert 100 adapted according to one embodiment of the invention. In this example, busing insert 100 is configured to be mated to an elbow terminator (not shown), such as described and illustrated in U.S. Pat. No. 7,083,450, which is hereby incorporated herein by reference. For instance, when completely coupled to a terminator, groove 111 accommodates a latching ring within the terminator, a probe is received within bushing 100 along longitudinal axis 110, and the cuff of the terminator just covers ring 103, Bushing insert 100 includes, inter alia, shoulder 107, grounding shield 101, ring 103, and non-conducting portion 102.

Grounding shield 101 operates to keep the outside surface of bushing 101 at ground potential, thereby providing a “dead front” for the safety of operators and others who may come into contact with the high-voltage electrical connector system. In many embodiments, grounding shield 101 is constructed of semiconductive ethylene propylene diene M-class (EPDM) rubber, and thus can conduct electrical charge. Attention is now drawn to FIG. 1B, which shows a view of a portion of bushing 100 of FIG. 1A. FIG. 1B shows a more detailed cut-away view of the interface of the various material surrounding J-ring 103. In this example, J-ring 103 includes axial protrusion 105 and trough 106. In FIG. 1B, there is a high-stress area where J-ring 103, grounding shield 101, and insulative portion 104 come together. Semiconductive material 101 comes to a point or ridge at this high-stress area. The present example embodiment overlays the high-stress point with insulative portion 104, thereby preventing arcing at voltages as high as 30.5 kV or higher.

The area where grounding shield 101 and insulative portion 104 come together at the outside surface of bushing insert 100 is a lower stress area. The axial extent of insulative portion 104 from J-ring 103 along the outside surface can be adjusted to eliminate the possibility of arcing. Specifically, the farther this lower-stress point is away from shoulder 107, the less the likelihood of an arc being able to form from the terminator probe (not shown) to grounding shield 101. For 25 kV and 30 kV applications of the IEEE STD 386 standard, a length of insulating portion 104 between ¼ inch and ⅝ inch is adequate to eliminate all or nearly all of the risk of flashover. In the various embodiments shown herein, the thickness of insulative portion 104 can be adapted for the specific use and may be influenced by factors such as operating voltage, material, and the like. For most IEEE STD 386 embodiments using molded thermoset plastic, a thickness of a tenth of an inch is adequate.

Prototypes tested showed unexpectedly positive results. For instance, Table 1 shows results of the OIACWT for crude, hand-made prototypes of the bushing insert shown in FIG. 1A, with nylon J-rings and semiconductive EPDM grounding shields. There are two groupings made with respect to cracks in the J-rings. One group “Cracks Included” includes prototypes tested that were confirmed to have very small cracks in their respective J-rings. “Cracks Culled” shows the same prototype set but without the data from bushings that included J-ring cracks. Table 1 shows that when an insert has a J-ring for vacuum relief but no other insulation, there was about a 20% pass rate for OIACWT option B. Furthermore, while not shown in the chart, merely including about ¼ inch of insulation over the end of a grounding shield of a bushing (without a J-ring) is expected to provide about a 0-5% passing rate for OIACWT option B. Since a J-ring alone provides about 20% success, and since insulation alone provides 0-5% success, one would expect a J-ring with added insulation (as shown in FIG. 1B) would provide between 20% and 25% success in OIACWT option B. However, Table 1 shows that a crude J-ring prototype with added insulation can be expected perform with about 90% success. Carefully manufactured bushing inserts can be expected to improve the approximately 90% success rate to at or near 100%. Thus, when paired together, a J-ring and grounding shield insulator exhibit synergy.

TABLE 1A
Crack Included

| | | 30.5 kV | % | | 27.5 kV | % | | 24.5 kV | % |
|---|---|---|---|---|---|---|---|---|---|
| Design | Attempted | Pass | Pass | Attempted | Pass | Pass | Attempted | Pass | Pass |
| Recessed | 5 | 1 | 20% | 11 | 2 | 18% | 0 | 0 | — |
| Groove no | | | | | | | | | |
| insulation | | | | | | | | | |
| Recessed | 2 | 0 | 0% | 17 | 12 | 71% | 8 | 8 | 100% |
| Groove | | | | | | | | | |
| 0.25″ | | | | | | | | | |
| insulation | | | | | | | | | |
| Recessed | 13 | 12 | 92% | 12 | 10 | 83% | 3 | 3 | 100% |
| Groove | | | | | | | | | |
| 0.625″ | | | | | | | | | |
| insulation | | | | | | | | | |

TABLE 1B
Cracks Culled

| | | 305 kV | % | | 27.5 kV | % | | 24.5 kV | % |
|---|---|---|---|---|---|---|---|---|---|
| Design | Attempted | Pass | Pass | Attempted | Pass | Pass | Attempted | Pass | Pass |
| Recessed | 5 | 1 | 20% | 11 | 2 | 18% | 0 | 0 | — |
| Groove no | | | | | | | | | |
| insulation | | | | | | | | | |
| Recessed | 0 | 0 | — | 14 | 12 | 86% | 8 | 8 | 100% |
| Groove | | | | | | | | | |
| 0.25″ | | | | | | | | | |
| insulation | | | | | | | | | |
| Recessed | 13 | 12 | 92% | 11 | 10 | 91% | 3 | 3 | 100% |
| Groove | | | | | | | | | |
| 0.625″ | | | | | | | | | |
| Insulation | | | | | | | | | |

Manufacturing bushing insert 100, in some embodiments, starts by making the components that, together, form bushing insert 100. A shield housing (not shown) houses the current-carrying parts of bushing 100, such as aluminum contact tube 120 that mates with the probe of the terminator. The shield housing is molded out of rubber. J-ring 203 is also made usually by molding, as is grounding shield 101 and insulative portion 104. The components are placed in an injection mold, where non-conducting rubber is injected into the space defined between the shield housing and the other components (J-ring 103, grounding shield 101, and insulative portion 104). For the example embodiments herein, J-rings can be made of any of a variety of materials, including, e.g., plastic, fiberglass, nylon, thermoset plastic, thermal plastic rubber (TPR), thermal plastic elastomer (TPE) and the like.

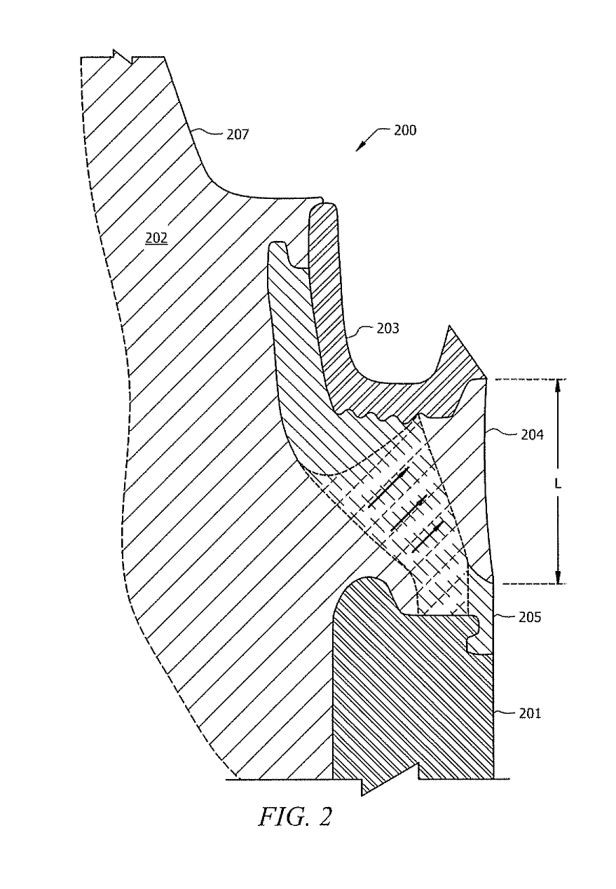

FIG. 2 is an illustration of exemplary bushing 200 adapted according to one embodiment of the invention. Specifically, FIG. 2 is a detailed cut-away view showing the various materials and layers in proximity to J-Ring 203. In addition to J-ring 203, bushing insert 200 also includes insulative portion 204, first grounding shield portion 205, second grounding shield portion 201I, and insulating rubber 202.

In bushing 200, the grounding shield is made of two parts (i.e., portions 201 and 205), which in this example are of different materials, though in other embodiments the grounding shield may be of the same or similar materials. The IEEE STD 386 standard requires that the conductive collar (of the grounding shield) be within a prescribed distance of shoulder (e.g., 207) of a bushing. The purpose of having the grounding shield close to the shoulder is to keep the dead front shell as long as possible for safety and to keep the electric field lines from escaping outside the bushing and making things hotter electrically. In the bushing of FIG. 1A, to fit J-ring in 103, conductive collar 101 is moved away from shoulder 107 to make room for J-ring 103. In other words, the design of FIG. 1A may not meet the shielding specification set forth in the IEEE STD 386 standard. Bushing insert 200 of FIG. 2 seeks to comply with the standard by disposing the conductive grounding shield so that it extends axially to a point very close to shoulder 207.

Also, the design of FIG. 2 shields the trough of J-ring 203 electrically from partial discharge. In FIG. 2, the ground plane formed by portions 201 and 205 goes under J-ring 203 and almost fully shields the entire length of J-ring 203. From the perspective of the trough, the nearest energized part is in the center of bushing 200 (not shown), which is separated from the trough by grounding shield portion 205. As a result, the electric field lines go from the energized parts of the insert (in the center of bushing 200 and not shown herein) toward the ground plane and stop there so that the electric filed lines do not penetrate into the air gap. Furthermore, as with the embodiment of FIG. 1, the ground plane is covered partially by insulative material (in this case, insulative portion 204) to inhibit flashover. The length of insulative portion 204 “L” can be adapted to a variety of applications, and can be around, e.g., ¼ inch to ⅝ inch for a bushing conforming to the IEEE STD 386 standard

Similar to the embodiment of FIG. 1A, manufacturing bushing insert 200, in some embodiments, starts by making the components that form bushing insert 200. The shield housing is molded out of rubber. First grounding shield portion 205 is over-molded on J-ring 203 to create a bond between the materials. In this example, first grounding shield portion 205 is made of a black semiconductive plastic, such as carbon-loaded plastic or nylon, metal-loaded plastic, and/or the like. Also, second grounding shield portion 201 is made by molding, e.g., semiconductive EPDM. Second grounding shield portion 201 is then snapped to the component that includes J-ring 203 and first grounding shield portion 205 using, e.g., interlocking tabs where portions 201 and 205 contact. The snap-on operation makes a component that includes J-ring 203, as well as the entire semiconductive grounding shield.

After the snap-on operation, the snapped-together component and the shield housing are placed into a mold. The mold injects insulative rubber into the space defined by the shield housing and the snapped-together component. The insulative rubber forms non-conductive portion 202 and bonds to portions 201 and 205 as well as to S-ring 203. In some embodiments, insulative portion 204 is independently molded as a piece of black insulative plastic to slide into place over the outside diameter bushing 200. This can be done before or after non-conductive portion 202 is molded.

Alternatively, some embodiments provide for a plurality of holes in grounding shield portion 205, represented by arrows in FIG. 2. The holes allow the insulative rubber of portion 202 to flow therethrough during injection, thereby forming insulative portion 204 out of rubber during the molding process.

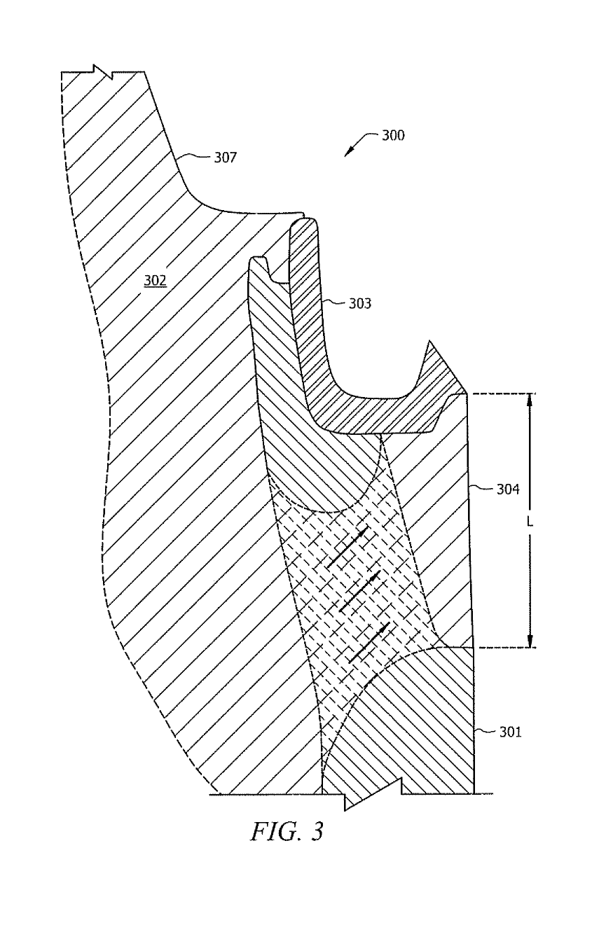

FIG. 3 is an illustration of exemplary bushing insert 300 adapted according to one embodiment of the invention. Specifically, FIG. 3 provides a detailed, cutaway view of bushing 300, showing the materials therein. The embodiment of FIG. 3 is somewhat similar to the embodiment of FIG. 2; however, bushing 300 utilizes single-piece grounding shield 301. The length of insulative portion 304 “L” can be adapted to a variety of applications, and can be around, e.g., ¼ inch to ⅝ inch for a bushing conforming to the IEEE STD 386 standard. The embodiment of FIG. 3 performs electrically in the same way that the embodiment of FIG. 2 performs, as described above.

Bushing 300 can be manufactured, e.g., by making J-ring 303, grounding shield 301, and internal shield housing (not shown) separately, then those pieces are put into an injection mold. In this example, grounding shield 301 includes a plurality of holes represented as arrows that let the insulative fill plastic flow therethrough. The fill insulation passes through the holes in grounding shield 301 to form insulative portion 304. The insulative fill rubber also forms non-conductive portion 302.

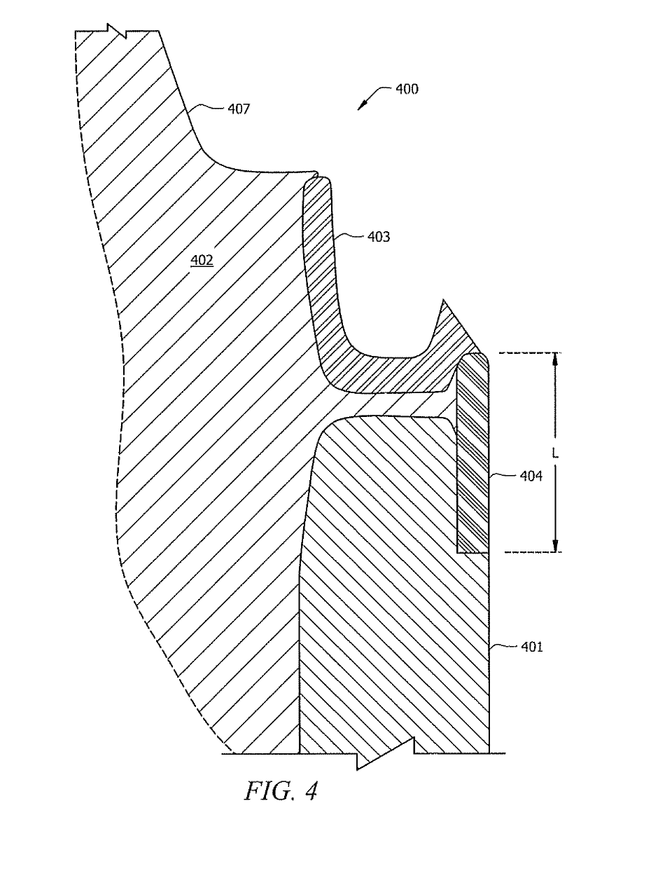

FIG. 4 is an illustration of exemplary bushing 400 adapted according to one embodiment of the invention. Specifically, FIG. 4 is a detailed, cut-away view showing the materials inside bushing 400. Bushing 400 provides insulative portion 404, which is adjacent to J-ring 403 and covers a portion of grounding shield 401. Bushing 400 does not include grounding underneath J-ring 403 and proximate shoulder 407, but does provide ease of manufacture.

Bushing 400 includes separate cuff 404 that can be made of molded rubber, plastic, or other insulative material. In one example, cuff 404, J-ring 403, grounding shield 401, and the housing shield (not shown) are independently made and arranged in a fill mold. Then insulative rubber is injected into the mold, thereby creating non-conductive portion 402. In one example, during the injection molding process, the insulative rubber is hot and not vulcanized. As the insulative rubber, J-ring 403, rubber cuff 404, and grounding shield 401 are exposed to heat, the insulative rubber forms molecular bonds with the materials of J-ring 403, rubber cuff 404, and grounding shield 401. The bonding between the materials creates a seal that prevents arcing between the probe of the terminator and grounding during a partial vacuum condition. The length of insulative portion 404 “L” can be adapted to a variety of applications, and can be around, e.g., ¼ inch to ⅝ inch for a bushing conforming to the IEEE STD 386 standard.

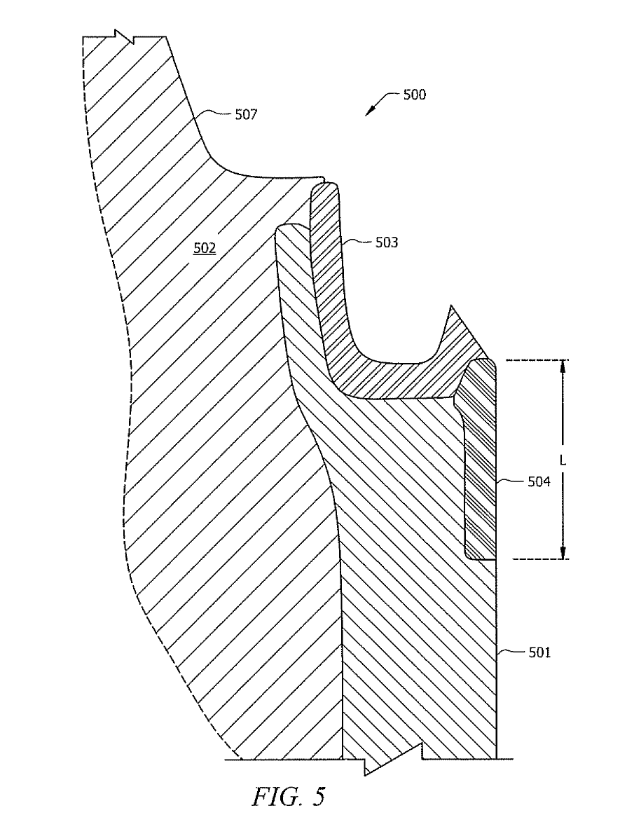

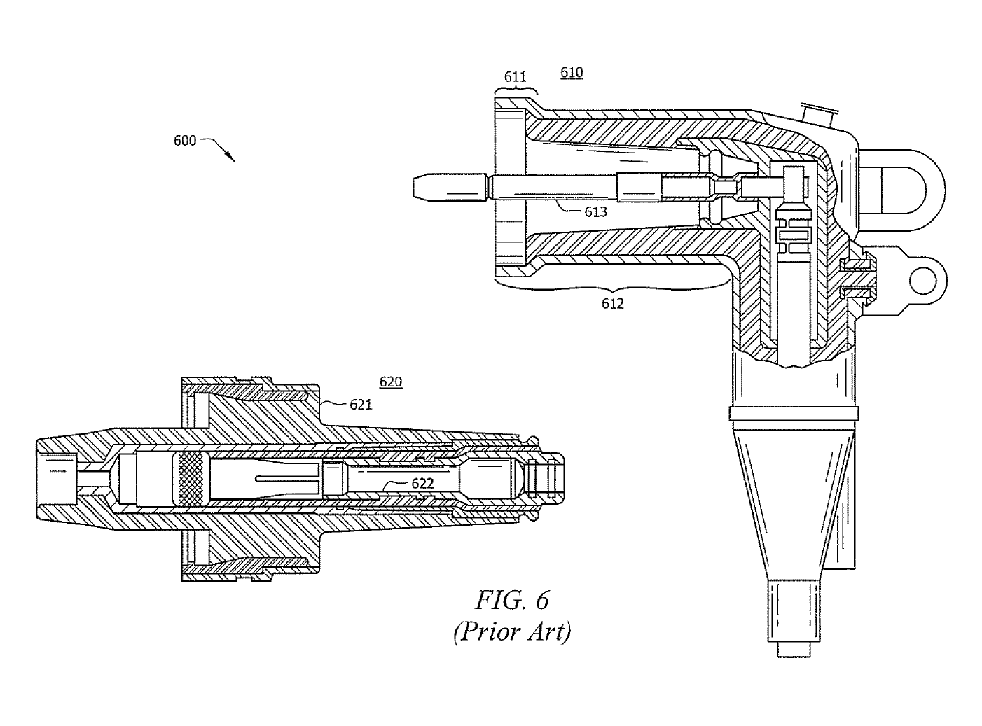

FIG. 5 is an illustration of exemplary bushing 500 adapted according to one embodiment of the invention. Specifically, FIG. 5 shows a detailed, cut-away view of a portion of bushing 500 in order to illustrate the grounding properties of one embodiment. Bushing 500 includes grounding shield 501, J-ring 503, insulative portion 504, and non-conductive portion 502. Grounding shield 501 extends axially almost up to shoulder 507 and provides IEEE STD 386-specified grounding. In bushing 500, the material of insulative portion 504 bonds with the material of J-ring 503 to provide a seal that withstands partial vacuum and prevents arcing.

In one example, bushing 500 is made using the following process. The various components are made individually. For instance, J-ring 503 is molded. J-ring 503 is then placed into a mold, where screw-ram injection is used to mold the insulating plastic of insulative portion 504. During the molding process, J-ring 503 and insulative portion 504 are bonded together to make, in effect, one physical piece. Then, the portion that includes pieces 503 and 504 is placed in a fill mold along with grounding shield 501 and a housing shield (not shown). Then, insulative rubber is screw-ram injected to form non-conducting portion 502. The rubber of non-conducting portion 502 bonds to J-ring 503 and to grounding shield 501. The length of insulative portion 504 “L” can be adapted to a variety of applications, and can be around, e.g., ¼ inch to ⅝ inch for a bushing conforming to the IEEE STD 386 standard.

In an alternate embodiment, J-ring 503 and insulative portion 504 are made of one piece of plastic, e.g., yellow insulating plastic. After fill molding has been performed, the length “L” is painted black so that the yellow of J-ring 503 contrasts with the surrounding colors and performs its latch indication function.

While the description herein has given examples of specific materials that may be used in various embodiments of the invention, it should be noted that other suitable materials can also be used. For instance, instead of EPDM rubber, some embodiments may use TPR or TPE, silicone rubber, epoxy, and/or the like. Moreover, dimensions given herein are for example only and should not be seen as limiting. Furthermore, while the embodiments herein have been described with respect to the IEEE STD 386 standard, embodiments of the invention can differ from the standard in many different respects. In fact, any high-voltage bushing that receives a probe from a terminator can be adapted according to the principles described herein.

Although the present invention and its advantages have been described in detail, it should be understood that various changes, substitutions, and alterations can be made herein without departing from the spirit and scope of the invention as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of manufacturing a bushing, the bushing comprising a longitudinal axis, a shoulder, a first end, and a second end, wherein the shoulder is between the first end and the second end, a ring arranged circumferentially around a first outside diameter of the bushing, the ring disposed between the shoulder and the second end, the ring including a channel therein defining a circumferential extension extending axially toward the first end, a ground shield disposed on a second outside diameter of the bushing between the ring and the second end, the ground shield comprising a semiconductive rubber collar that forms part of an outer surface of the bushing and extends circumferentially under a portion of the ring, and an insulative portion adjacent the ring and disposed circumferentially over a portion of the ground shield, the method comprising:
placing the ring and the ground shield into a mold, the ground shield including a plurality of holes therein; and
injecting insulative material into the mold to create an insulative layer within a cavity formed by the ring and the ground shield, the plurality of holes in the ground shield allowing some of the insulating material to flow therethrough to create the insulative portion adjacent the ring.

2. The method of claim 1, wherein the ground shield extends from an outside surface of the bushing to under a portion of the ring.

3. The method of claim 1, wherein the insulative material comprises a thermoset plastic.

4. The method of claim 1, wherein the insulative material creates a sealing bond with the ring.

5. A method of manufacturing a bushing, the bushing comprising a longitudinal axis, a shoulder, a first end, and a second end, wherein the shoulder is between the first end and the second end, a ring arranged circumferentially around a first outside diameter of the bushing, the ring disposed between the shoulder and the second end, the ring including a channel therein defining a circumferential extension extending axially toward the first end, a ground shield disposed on a second outside diameter of the bushing between the ring and the second end and extending from an outside surface of the bushing to under a portion of the ring, and an insulative portion adjacent the ring and disposed circumferentially over a portion of the ground shield, the method comprising:
coupling a first assembly to a second assembly, the first assembly comprising the ring and a first semiconductive portion extending circumferentially under a portion of the ring, the first semiconductive portion having a plurality of holes therein; the second assembly comprising a second semiconductive portion forming at least a part of an outside surface of the bushing;
placing the first assembly and the second assembly into a mold; and
injecting insulative material into the mold to create an insulative layer within a cavity formed by the first and second assemblies, the plurality of holes in the first semiconductive portion allowing some of the insulating material to flow therethrough to create the insulative portion adjacent the ring.

6. The method of claim 5, wherein the first semiconductive portion comprises one or more of carbon-loaded plastic and metal-loaded plastic.

7. The method of claim 5, wherein the coupling the first assembly and the second assembly comprises snapping the first assembly to the second assembly.
